(19) United States
(12) Patent Application Publication
(10) Pub. No.: US 2026/0165259 A1
(43) Pub. Date: Jun. 18, 2026

(54) CONTROLLED ENVIRONMENT AGRICULTURAL SYSTEMS AND METHODS USING COMPUTER VISION

(71) Applicant: The Texas A&M University System, College Station, TX (US)

(72) Inventors: Surendra Surujdeo-Maharaj, Houston, TX (US); Azlan Zahid, Plano, TX (US); Aruna Weerasooriya, Katy, TX (US); Pratyush Srivastava, Hempstead, TX (US); Joshua Robin Rieger, Hackley, TX (US)

(21) Appl. No.: 19/420,117

(22) Filed: Dec. 15, 2025

Related U.S. Application Data
(60) Provisional application No. 63/735,081, filed on Dec. 17, 2024.

(51) Int. Cl. A01G 9/24; G06T 7/60; G06V 10/70; G06V 10/94; G06V 20/10; G06V 20/52

(52) U.S. Cl. CPC A01G 9/246; A01G 9/247; A01G 9/249; G06T 7/60; G06V 10/70; G06V 10/95; G06V 20/188; G06V 20/52; G06T 2200/24; G06T 2207/30188; G06T 2207/30232

(57) ABSTRACT

Disclosed are systems and methods for controlled environment agriculture. A system includes at least one sensor that collect data that includes at least one of (i) plant characteristic data corresponding to one or more characteristics of the plant and (ii) environment characteristic data corresponding to one or more characteristics of an environment in or around a container in which a plant is grown. An actuator is used to adjust a property of the environment in or around the container. A control subsystem receives the collected data and causes display of at least a portion of the received data on an electronic display and/or user device. The control subsystem also controls the actuator to adjust properties of the environment in which the plant is grown based at least in part on the received data.

### CROSS-REFERENCE TO RELATED APPLICATIONS

This application claims the priority of U.S. Provisional Appl. Ser. No. 63/735,081, filed Dec. 17, 2024, the entire disclosure of which is incorporated herein by reference.

### FIELD OF TECHNOLOGY

The present invention relates generally to the field of controlled-environment agriculture. More specifically, the invention relates, in certain embodiments, to systems and methods for controlled environment agriculture using computer vision and/or artificial intelligence.

### BACKGROUND

Controlled environment agriculture refers to the practice of growing crops indoors in environments in which plant growth conditions can be more controlled than is possible outdoors. Hydroponics is an example of controlled environment agriculture. While controlled environment agriculture can provide improvements to crop yield and quality, existing systems for this method of agriculture suffer from certain drawbacks and disadvantages. For example, previous controlled environment agriculture technologies are often expensive, difficult to use, and require extensive technical expertise, thereby providing both practical and technological bottlenecks the widespread adoption of these tools. For instance, previous technology typically requires for highly specialized equipment and associated knowledge for successful operation. Previous technologies fail to provide easily interpretable metrics of plant health and growth. For example, system controls were typically either too rigid, without an ability to customize or adjust operations, or so complex as to require specially trained technicians to oversee their operation. As such, a need exists for improved and more user-accessible tools for controlled environment agriculture.

### SUMMARY

This disclosure not only encompasses the recognition of the problems of previous controlled environment agriculture technologies described above but also provides solutions to these and other technological problems. For example, this disclosure provides improved systems and methods for controlled environment agriculture with greater usability and increased access to environmental and plant growth characteristics for both identifying optimized growth routines (e.g., schedules of plant lighting, watering, etc.) and easily implementing these routines. The systems and methods of this disclosure may have a lower cost for manufacturing and/or operation. In some embodiments, the systems and methods of this disclosure may facilitate more user-friendly operations, such that untrained individuals can successfully operate the tools via an informative and intuitive graphical user interface. In some embodiments, the improved insights available through efficient data collection and analysis can facilitate improved plant growth in terms of achieving a desired yield and/or plant phenotype. In some embodiments, the systems and methods of this disclosure employ specially developed controls employing computer vision, artificial intelligence, and/or other improved control algorithms to provide unique insights into plant health and allow timely actions to improve and/or control plant growth.

An aspect of the present disclosure provides a system, comprising: a container configured to hold a plant; at least one sensor configured to collect data comprising at least one of (i) plant characteristic data corresponding to one or more characteristics of the plant and (ii) environment characteristic data corresponding to one or more characteristics of an environment in or around the plant; at least one actuator configured to adjust a property of the environment in or around the plant; an electronic display; and a control subsystem communicatively coupled to the at least one sensor, the at least one actuator, and the electronic display, the control subsystem configured to: receive the collected data; cause display of at least a portion of the received data on the electronic display; and control the at least one actuator to adjust the property of the environment based at least in part on the received data.

In some embodiments, the at least one sensor comprises at least one of an image sensor, a pH sensor, a temperature sensor, a humidity sensor, an electrical conductivity sensor, and a chemical sensor. In some embodiments, the plant characteristic data comprises a plant image; and the control subsystem is further configured to: determine a plant size or plant color based on the plant image; and cause display of the plant size or plant color on the electronic display. In some embodiments, the at least one sensor comprises a top-view image sensor configured to collect top-view images of the plant and a side-view image sensor configured to collect side-view images of the plant. In some embodiments, the control subsystem is further configured to determine, using the top-view images and side-view images, a plant mass of the plant and cause display of the plant mass on the electronic display.

In some embodiments, the control subsystem is further configured to control the at least one actuator to adjust the property of the environment based at least in part on the plant mass. In some embodiments, the control subsystem is further configured to determine a plant height using the side-view images. In some embodiments, the environment characteristic data comprises one or more of a temperature of the environment, a humidity level of air in the environment, an amount of carbon dioxide in the environment, a pH of soil in the container, a moisture level of the soil, and an amount or presence of one or more nutrients in the soil. In some embodiments, the least one actuator comprises one or more of a light, a fluid pump, and a heater. In some embodiments, the control subsystem is further configured to determine a plant growth characteristic based on the collected data and cause display of the plant growth characteristic on the electronic display.

In some embodiments, the control subsystem is further configured to determine that the plant growth characteristic is outside a predefined range associated with expected growth of the plant and, in response to determining that the plant growth characteristic is outside the predefined range, provide a notification for display on the electronic display or on a user device in communication with the control subsystem, the notification indicating a corrective action is indicated. As used herein, “determining that a corrective action is indicated” means identifying, based on collected data, that one or more environmental or plant growth parameters deviate from desired or expected values, such that an adjustment, such as modifying the amount, timing, or intensity of light, water, nutrients, temperature, or other environmental factors, is recommended to promote optimal plant growth or to address a detected issue. In some embodiments, the control subsystem is further configured to determine, based on the collected data, that a growth objective is met and provide a notification for display on the electronic display or on a user device in communication with the control subsystem, the notification indicating that the growth objective is met. As used herein, a “growth objective” refers to a predefined target or goal related to plant development, such as achieving a specific plant mass, height, color, phenotype, or other measurable characteristic of plant growth.

In some embodiments, the control subsystem comprises a local controller comprising a memory configured to store the collected data and a processor configured to present a graphical user interface on the electronic display, the graphical user interface showing collected data and options for controlling the at least one actuator. In some embodiments, the local controller is communicatively coupled to a server, wherein the server is configured to analyze collected data using one or more artificial intelligence or machine learning algorithms to generate analysis results and provide the analysis results to the local controller for presentation on the electronic display.

In another aspect, the present disclosure provides a method comprising, by a controller of a controlled-environment agriculture system: receiving data collected by at least one sensor of the controlled-environment agriculture system, the received data comprising at least one of (i) plant characteristic data corresponding to one or more characteristics of a plant grown in the controlled-environment agriculture system and (ii) environment characteristic data corresponding to one or more characteristics of an environment in or around the plant; causing display of at least a portion of the received data on an electronic display of the controlled-environment agriculture system; and controlling at least one actuator of controlled-environment agriculture system to adjust a property of the environment based at least in part on the received data.

In some embodiments, the plant characteristic data comprises a plant image; and the method further comprises determining a plant size or plant color based on the plant image and causing display of the plant size or plant color on the electronic display. In some embodiments, the at least one sensor comprises a top-view image sensor configured to collect top-view images of the plant; and a side-view image sensor configured to collect side-view images of the plant. In some embodiments, the method further comprises determining, using the top-view images and side-view images, a plant mass of the plant and causing display of the plant mass on the electronic display. In some embodiments, the method further comprises controlling the at least one actuator to adjust the property of the environment based at least in part on the plant mass.

In some embodiments, the method further comprises determining a plant growth characteristic based on the collected data and causing display of the plant growth characteristic on the electronic display. In some embodiments, the method further comprises determining that the plant growth characteristic is outside a predefined range associated with expected growth of the plant and, in response to determining that the plant growth characteristic is outside the predefined range, providing a notification for display on the electronic display or on a user device, the notification indicating a corrective action is indicated.

In some embodiments, the method further comprises determining, based on the collected data, that a growth objective is met and providing a notification for display on the electronic display or on a user device, the notification indicating that the growth objective is met. In some embodiments, the method further comprises, by a server communicatively coupled to the controller, analyzing a portion of the received data using one or more artificial intelligence or machine learning algorithms to generate analysis results and providing the analysis results to the controller for presentation on the electronic display.

In yet another aspect, the present disclosure provides a control subsystem for a controlled-environment agriculture system, the control subsystem comprising at least one processor configured to receive data collected by at least one sensor of the controlled-environment agriculture system, the received data comprising at least one of (i) plant characteristic data corresponding to one or more characteristics of a plant grown in the controlled-environment agriculture system and (ii) environment characteristic data corresponding to one or more characteristics of an environment in or around the plant; cause display of at least a portion of the received data on an electronic display of the controlled-environment agriculture system; and control at least one actuator of controlled-environment agriculture system to adjust a property of the environment based at least in part on the received data.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 shows a block diagram of an example agriculture system of this disclosure.

FIG. 2 shows a front-side view of an example agriculture system of this disclosure.

FIG. 3 shows a back-side view of the example agriculture system of FIG. 2.

FIG. 4 shows an example view of a graphical user interface (GUI) of this disclosure.

FIG. 5 shows a front-side view of another example agriculture system of this disclosure.

FIG. 6 shows a flowchart of an example method of operating an agriculture system of this disclosure.

FIG. 7 shows an image of seeds germinated and monitored using an agriculture system of this disclosure.

FIG. 8 shows an image of eggs monitored during development using an agriculture system of this disclosure.

FIG. 9 shows images of fungi grown and monitored using an agriculture system of this disclosure.

FIG. 10 shows side-view images of a plant grown and monitored using an agriculture system of this disclosure along with a color-based image analysis of the plant.

FIG. 11 shows computer vision-based analysis results of leaves, stems, and roots of a plant grown and monitored using an agriculture system of this disclosure.

FIG. 12 shows images of different plants grown and monitored using an agriculture system of this disclosure under different lighting conditions.

### DETAILED DESCRIPTION

As described above, previous indoor agriculture systems are cost prohibitive and require extensive specialized knowledge and training to operate. The present disclosure therefore represents a significant advance in the art in that it provides systems and methods that significantly reduce the cost and complexity of agriculture systems. In particular embodiments, a controlled-environment agriculture system is provided that is low-cost and user-friendly. The disclosed system allows users a high level of control of the growth environment of plants, such as control of light, water, temperature, and nutrients, while also facilitating the collection of real-time data to monitor plant growth, health, and other plant characteristics (e.g., phenotype, mass, etc.). The disclosed systems can be implemented at various scales as appropriate for a given use. For instance, embodiments of the disclosed system may be scaled for use in education, in research, or at home.

The disclosed systems integrate both hardware and software, allowing users to locally access and store data without needing internet access for most or all functions. The hardware includes a range of physical sensors and actuators that work together to monitor and optimize, or at least improve, plant growth in a controlled environment. For example, a software layer may control a backend, which records sensor data and displays relevant information to the user using the front-end graphical user interface (GUI), which is accessible on a touch screen display of the device itself or through another user device (e.g., a smartphone or tablet). The GUI allows the user to control the plant-growth environment without specialized technical knowledge.

In some embodiments, advanced analytical tools employing artificial intelligence (AI) and/or computer vision are employed to help monitor plant growth and predict most probable outcomes. The disclosed systems integrate these analytical tools in a manner that is user-friendly and accessible to non-experts, effectively reducing or even eliminating the need for programming skills and other technical training.

The disclosed systems and methods may be used to determine optimized or improved plant growth conditions (also referred to as “growth recipes” or “growth schedules”) that can be easily distributed to users (e.g., via user-friendly software updates) and automatically implemented to improve plant growth outcomes. For example, a growth schedule may indicate an amount, intensity, and frequency of light needed to achieve a desired plant growth outcome (e.g., plant mass, phenotype, etc.). Improved growth schedules may be determined by testing growth under different controlled conditions and/or through analysis of growth data obtained from a number of growers (e.g., who have opted in to a data sharing agreement).

### I. Controlled-Environment Agriculture System

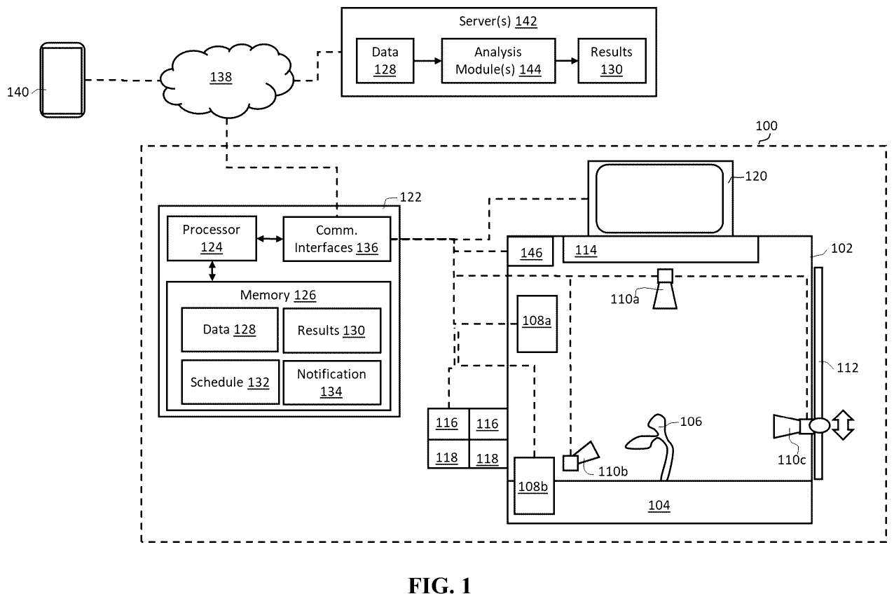

FIG. 1 shows a block diagram of an example controlled-environment agriculture system 100 of this disclosure. The controlled-environment agriculture system 100 generally facilitates improved monitoring and control of plant growth, resulting in an improved ability to study plant growth and optimize plant growth outcomes. All or a portion of the power used by the controlled-environment agriculture system 100 may be provided by solar energy.

The controlled-environment agriculture system 100 includes a housing 102 connected to a container 104 configured to hold one or more plants 106. The housing 102 holds other components of the systems, such as the various sensors and actuators described below, while also providing for optional walls and/or doors to maintain a separate internal environment from a surrounding environment. The container 104 is generally a surface or vessel of an appropriate size and shape to hold soil or other vessels for growing a number of plants 106. The example of FIG. 1 shows a single plant 106. However, the container 104 can be shaped to hold any appropriate number of plants 106. Also, while this disclosure primarily describes monitoring and optimizing plant growth, it should be understood that other environment-dependent specimens or processes can be monitored using the controlled-environment agriculture system 100 (see, e.g., Example 2 below in which egg development is monitored and Example 3 in which fungi growth is monitored).

The controlled-environment agriculture system 100 includes sensors, such as imaging sensors or cameras 110a-c and other sensors 108a, b, which collect data related to characteristics of the plant(s) 106 and the environment in or around the container 104. Imaging sensors 110a-c are generally positioned and configured to take images of the plant(s) 106 from various view-points. In the example of FIG. 1, image sensor 110a is a top-view sensor that collects top-view images of the plant(s) 106, while image sensors 100b and 110c are side-view image sensors that collect side-view images of the plant(s) 106. In this example, image sensor 110c is movable via an arm 112, which facilitates movement of the image sensor 110c along one or more spatial axes. FIG. 1 illustrates movement up and down along a Y axis. However, arm 112 may provide additional range of movement (e.g., on multiple X, Y, Z axes). For example, the arm 112 may be a mechanical arm that can move on multiple axes.

The imaging sensors 110a-c may be cameras (e.g., capable of taking color images of the plant(s) 106), thermal imaging sensors (e.g., capable of taking infrared images of plant(s) 106), and/or depth sensors (e.g., capable of taking depth or 3D images of plant(s) 106). In some embodiments, at least one of the imaging sensors 110a-c is a multi/hyperspectral camera. A multi/hyperspectral camera is an imaging sensor that collects information from across the electromagnetic spectrum, and the resulting data can provide insights into plant development and plant health. Each pixel of an image collected by a multi/hyperspectral camera includes spectral information from a relatively broader spectral range and can provide information about plant health. Information from the imaging sensors 110a-c is provided to the control subsystem 122 as part of data 128 to be made accessible via the electronic display 120 and/or for analysis using computer vision and/or AI (e.g., by the server(s) 142), as described below.

Sensors 108a, b may be sensors for measuring other properties of the plant(s) 106 and/or the plant growth environment. Sensors 108a, b may include pH sensor(s), temperature sensor(s), humidity sensor(s), electrical conductivity sensor(s), and/or chemical sensor(s). For example, sensor(s) 108a may measure air properties in the environment of the plant(s) 106. The air properties may include temperature, humidity level, CO₂ level, and the like. In some embodiments, sensor 108a includes a Raman spectral sensor configured to detect volatile emissions associated with fruit ripening and/or terpene expression. Sensor(s) 108b may measure properties of the soil in which the plant(s) 106 grow, such as soil temperature, soil moisture level, CO₂ content of the soil, chemical nutrient content of the soil, pH of the soil, and the like. Information from sensors 108a, b is included in data 128 provided to the control subsystem 122.

The controlled-environment agriculture system 100 includes actuators, such as light(s) 114 fluid pump(s) 116, and heater/cooler 146, which adjust the growth environment of the plant(s) 106 based on information provided by sensors 108a, b and 110a-c. The lights 114 may be light-emitting diodes (LEDs). The lights 114 may have a controllable frequency and intensity, which can be adjusted to alter or improve plant growth characteristics and/or the phenotype of grown plant(s) 106 (see, e.g., Example 6, described below).

Fluid pump(s) 116 provide a flow of irrigation fluid and/or nutrient-providing fluid from reservoirs 118. The fluid pumps 116 can include a set of fluid pumps which is each coupled to a corresponding reservoir 118. Each reservoir 118 can store water, water at a certain pH, and/or water with certain added nutrients, such as nitrogen and phosphorous. In this way, the pumps 116 not only provide irrigation but also can be used to tune the pH and nutrient content of the soil.

Heater/cooler 146 may be adjusted to maintain a temperature of the environment of the plant(s) 106, as measured by sensors 108a and/or 108b (or thermal images from any of image sensors 110a-c), within a predefined temperature range. The heater/cooler 146 may maintain the plant-growth environment below a predefined maximum temperature above which plant growth may be hindered and above a predefined minimum temperature below which plant growth may be hindered. The heater/cooler 146 may include a heating element, such as an electrical heater or heat exchanger. The heater/cooler 146 may include a cooling element, such as a coil containing cooled refrigerant. The heater/cooler 146 may include a fan for circulating air through the heating and/or cooling elements and into the growth environment.

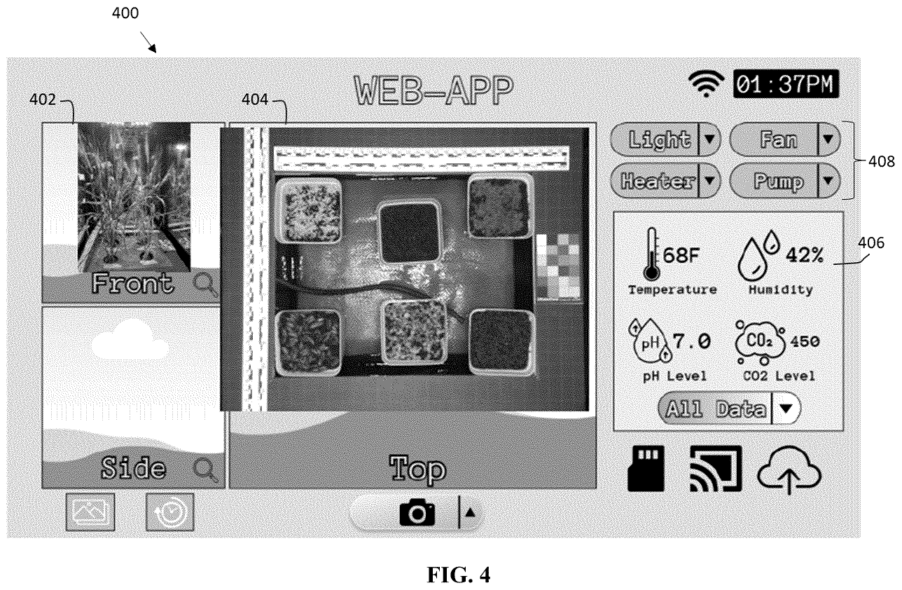

The controlled-environment agriculture system 100 includes an electronic display 120. The electronic display 120 may be a touchscreen. The electronic display 120 allows real-time presentation of data associated with the operation of the controlled-environment agriculture system 100. The electronic display 120 may present a GUI that provides display of system data and allows input of controls for adjusting operation of the system 100. An example GUI displayed on the electronic display 120 is shown in FIG. 4 and described below.

The controlled-environment agriculture system 100 includes a control subsystem 122 that is coupled to sensors 108a,b, image sensors 110a-c, actuators (e.g., lights 114, fluid pumps 116, and heater/cooler 146), and the electronic display 120. The control subsystem 122 may be a controller that executes software to integrate data into a GUI that is programmable and gives real-time or near real-time data access (e.g., for monitoring the effects of treatments on plant growth). The control subsystem 122 generally receives data 128 collected from sensors 108a,b and image sensors 110a-c, causes display of at least a portion of the received data 128 on the electronic display 120, and controls at least one actuator to adjust property(ies) of the plant-growth environment.

The example control subsystem 122 includes a processor 124, memory 126, and communications interface 136. The processor 124 executes instructions stored in memory 126 to perform the operations described in this disclosure. The processor may include one or more processors.

The memory 126 stores the data 128 collected by sensors 108a,b, 110a-c, results 130 of data analysis, schedules 132 for controlling actuators, and notifications 134, which may be displayed on the electronic display 120 or sent to a user device 140 (e.g., a smartphone, tablet, or personal computer). Data 128 may include a record of sensor measurements and actuator settings over time. Data 128 may be stored in an exportable format, such that it can exported for manual analysis by a user. Results 130 include properties or characteristics determined using data 128. For example, results 130 may include plant growth rates, plant heights, plant masses, and the like. Schedules 132 correspond to predefined schedules of actuator actions (e.g., for providing irrigation, light, nutrients, and the like. Schedules 132 may include setpoint or target values for environment properties, such as temperature setpoints, humidity level setpoints, soil nutrient or pH setpoints, and the like. Schedules 132 may be specific to a given plant or a desired plant phenotype or other growth outcome. As described further below, notifications 134 are generated to provide feedback when user attention is needed, such as when an irrigation/nutrient reservoir 118 is empty, a plant growth target is reached, or other intervention is indicated as needed. The memory 126 may include one or more disks, tape drives, or solid-state drives, and may be used to store programs when such programs are selected for execution and to store instructions and data that are read during program execution. The memory 126 may be volatile or non-volatile and may comprise read-only memory (ROM), random-access memory (RAM), ternary content-addressable memory (TCAM), dynamic random-access memory (DRAM), and/or static random-access memory (SRAM).

The communications interface 136 couples the control subsystem 122 to the sensors 108a,b, 110a-c, actuators (e.g., lights 114, fluid pumps 116, and heater/cooler 146), electronic display 120, and a network 138. Through the network 138, the control subsystem 122 is coupled to one or more servers 142. For example, data 128 may be received by the control subsystem 122 via the communications interface 136, and control signals may be sent to the actuators via the communications interface 136. As another example, the control subsystem 122 may send notifications 134 to the user device 140 via the communications interface 136. As another example, the processor 124 may use the communications interface 136 to present the GUI on the electronic display 120. The GUI shows collected data 128 and options for controlling actuators, such as by adjusting frequency and/or intensity of lights 114, adjusting pump rates provided by pumps 116, and/or adjusting environment temperature using heater/cooler 146.

In some embodiments, the control subsystem 122 acts as a local controller that handles collection of sensor data and sending of control signals, while more complex or resource-intensive analysis is performed by the server 142. The server 142 may analyze collected data 128 using one or more analysis modules 144 implementing artificial intelligence or machine learning algorithms to generate results 130. For example, the server(s) 142 may use appropriately trained AI models to determine results 130 that provide an improved schedule 132 for providing irrigation, nutrients, light of a given intensity and frequency, and temperature setpoints. The server(s) 142 may use computer vision algorithms to more accurately characterize plants from images (see Example 5 below). This may provide more accurate information on plant growth over time. The results 130 of this analysis may include these properties. Results 130 may include improved schedules 132 for providing irrigation, lighting, nutrients, etc. to improve the growth of a given plant or obtain a plant with a desired phenotype. The results 130 are provided to the control subsystem 122 for updating schedules 132, sending notifications 134, and/or presentation on the electronic display 120 and/or user device 140.

In some embodiments, the control subsystem 122 (and/or server(s) 142) determine plant size and/or plant color based on collected images (e.g., obtained from image sensors 110a-c) and causes display of the plant size and/or plant color on the electronic display 120. In some embodiments, the control subsystem 122 determines a plant growth characteristic based on the collected data 128. The plant growth characteristic may be a height, mass, color, or other property indicative of plant growth, phenotype, and/or health. The plant growth characteristic may be displayed on the electronic display 120. If the control subsystem 122 determines that the plant growth characteristic is outside a predefined range associated with expected growth of the plant (e.g., that the plant is growing too fast or too slow for proper development), a notification 134 may be provided for display on the electronic display 120 and/or on the user device 140. The notification 134 may indicate that a corrective action is indicated or needed.

In some embodiments, the control subsystem 122 (and/or server(s) 142) determines an estimated mass of the plant 106 using top-view images from image sensor 110a and side-view images from image sensors 110b and/or 110c. The plant's mass may be determined over time to determine plant growth rate in units of mass per time. The plant's mass may be determined using computer vision and/or AI algorithms (e.g., using analysis modules 144). The plant mass may then be presented (e.g., as a growth rate or as a function of time) on the electronic display 120, such that a user can readily evaluate plant growth under the currently implemented schedule 132. The control subsystem 122 may adjust the schedule 132 if a target growth rate is not being met. For example, the control subsystem 122 may use the actuators (e.g., lights 114, fluid pumps 116, and heater/cooler 146) to adjust properties of the growth environment based at least in part on the calculated plant mass. For instance, the control subsystem 122 may compare calculated plant mass or growth rate to a known healthy or desired plant mass or growth rate. If these values are not aligned or within a threshold level of each other, the schedule 132 may be adjusted to change amount/intensity/frequency of light provided, amount of irrigation and nutrients provided, setpoint temperatures, and the like in order to proactively improve plant growth.

The control subsystem 122 may determine a plant height using side-view images collected by image sensors 110b and/or 110c. Plant height may be used similarly to the plant mass described above. For example, the plant heigh may be used to determine whether a target growth rate in units of height per time is being met and proactively adjust schedule 132 to achieve the desired height or growth rate.

In some embodiments, the control subsystem 122 determines, based on the collected data 128, that a growth objective is met (e.g., that a target mass, height, phenotype, or other characteristic is achieved) and provides a notification 134 indicating the objective is met. The notification 134 may be displayed on the electronic display 120 and/or on the user device 140 in communication with the control subsystem 122. In some embodiments, the growth objective may be that a plant is ready to be harvested. For example, Raman spectral sensors included in sensors 108a, b may detect volatile emissions associated with fruit ripening and/or terpene expression and used to detect fruit ripening. As a result, a notification 134 may be sent indicating the fruit is ripe.

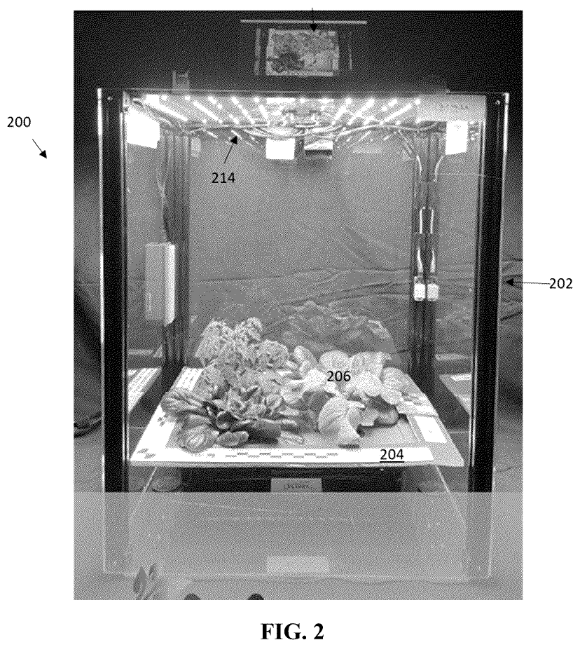

FIG. 2 shows a front-side view of another example controlled-environment agriculture system 200 of this disclosure. The controlled-environment agriculture system 200 includes a housing 202 with transparent windows, at least one of which is movable to allow access to specimens inside the housing 202. Plants 206 are growing and being monitored in the container 204 within the housing 202. Cameras and sensors are located around the housing 202 to monitor the growth environment and/or the plants 206, as described above with respect to image sensors 110a-c and other sensors 108a,b of FIG. 1. A heater/cooler provides heating and/or cooling to the environment within the housing 202, as described with respect to heater/cooler 146 of FIG. 1. Controllable, and optionally frequency tunable, lights 214 are at the top of the housing 202 and directed towards the plants 206 to provide controlled lighting to the plants 206, as described above with respect to lights 114 of FIG. 1. An electronic display 220 is on top of the housing to provide insights into plant growth and health and allow user control of the environment within the housing 202.

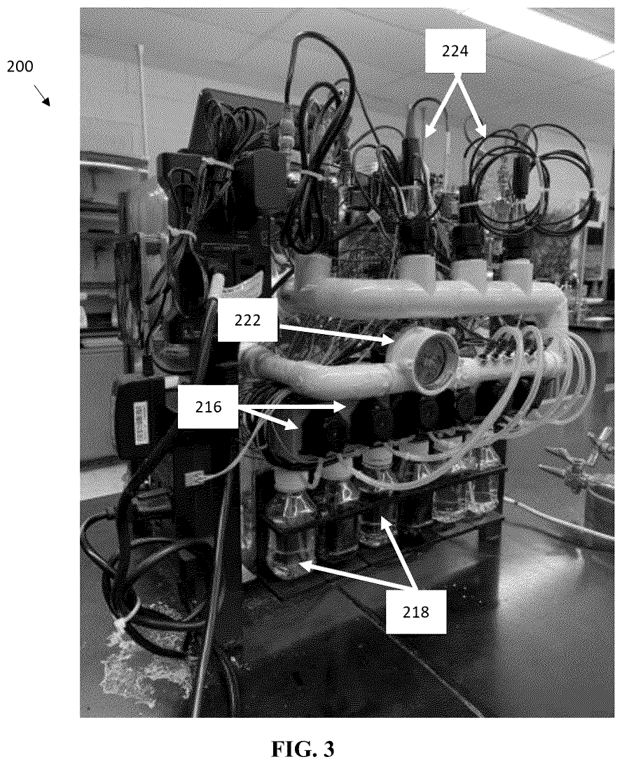

FIG. 3 shows a back-side view of the example controlled-environment agriculture system 200 of FIG. 2. In this view, fluid pumps 216 are visible that provide a controlled flow of water/nutrients from reservoirs 218. Sensor connections 224 provide signal connection to the control subsystem (described above with respect to FIG. 1). A fan 222 provides a controlled flow of air through the environment of the system 200.

FIG. 4 shows an example GUI 400 for display on the electronic display (e.g., electronic display 120) of the controlled-environment agriculture systems of this disclosure. The GUI 400 includes various panels showing different sensor measurements and control options. For example, panel 402 shows a front-view image of plants growing in the system. Panel 404 shows a top-down image of the various containers of plants currently growing in the system. Panel 406 shows other sensor measurements, including temperature, humidity level, pH level, and carbon dioxide level. Panel 406 includes an “All Data” button that can be selected to view other available senor readings. Control buttons 408 can be selected to control system actuators, including lights, a fan, a heater, and a pump.

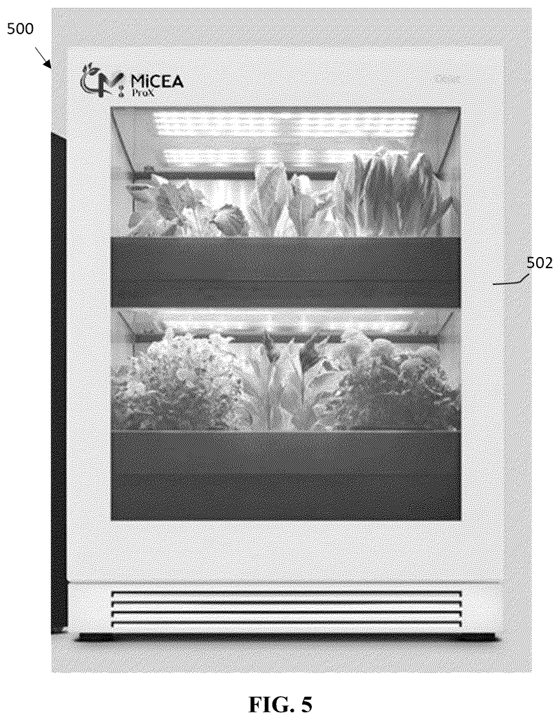

As described above, the controlled-environment agriculture systems of this disclosure may be adapted for different purposes, such as for education, research, and in-home use. While the examples of FIGS. 2 and 3 may be preferred for education or research purposes, FIG. 5 shows a front-view of another example controlled-environment agriculture system 500 adapted for in-home use with various electrical and fluid connections covered by a housing 502 that includes a door.

### II. Operation of a Controlled-Environment Agriculture System

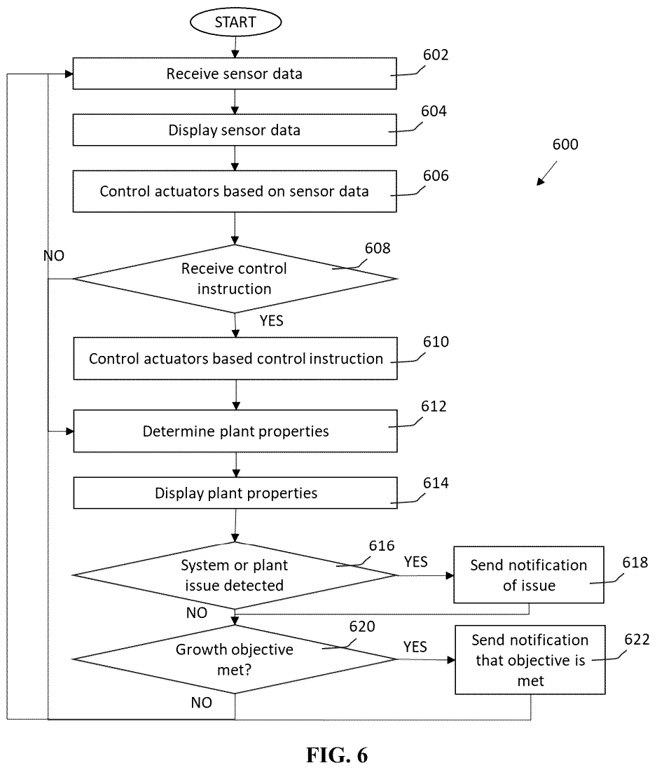

FIG. 6 illustrates an example method 600 of operating the controlled-environment agriculture systems of this disclosure. Steps of the method 600 may be performed by the control subsystem 122 and/or the server(s) 142 of FIG. 1. The method 600 may begin at step 602 where sensor data (e.g., data 128) is received by the control subsystem. At step 604, sensor data (or a predefined and/or selected portion of the sensor data) is displayed on the electronic display. At step 606, the various actuators (e.g., fluid pumps, heater/cooler, lights, etc.) are controlled based on the sensor data. For example, the actuators may be controlled based on a predefined schedule (e.g., schedule 132). Actuators may be controlled based on setpoint values indicated in the schedule (e.g., to achieve a target environment temperature, humidity level, soil pH, etc.).

At step 608, the control subsystem determines whether a control instruction is received. For example, a control instruction may be provided through a touchscreen of the electronic display and/or from a user device. If a control instruction is not received, the control subsystem proceeds to step 612. However, if a control instruction is received, the control subsystem proceeds to step 610 and operates the actuators based on the control instruction. For instance, if the control instruction is to increase light intensity, the control subsystem causes the light intensity to be increased.

At step 612, plant properties are determined. Plant properties may include a plant height, a plant mass, a plant color, or the like, as described in greater detail above with respect to FIG. 1. At step 614, the plant property is displayed on the electronic display. For example, a value corresponding to a current plant property may be displayed. As another example, a historical record of the plant property (e.g., plant mass over time) may be presented as a line graph or other visual representation of the data.

At step 616, the control subsystem determines whether a system or plant issue is detected. For example, the control subsystem may detect that a target temperature or humidity level is not being reached. For example, the control subsystem may detect that a plant is not on trajectory to meet a growth goal. If this is the case, the control subsystem proceeds to step 618 and sends a notification of the detected issue. If this is not the case, the control subsystem proceeds to step 620.

At step 620, the control subsystem determines whether a growth objective is met. For example, the control subsystem may determine whether a target plant height, mass, color, or the like has been achieved. If this is the case, the control subsystem proceeds to step 622 and sends a notification indicating that the growth objective is met. This notification may be displayed on the electronic display and/or sent to a user device. The notification may facilitate timely harvesting of the plant with desired characteristics.

### EXAMPLES

The following examples are included to demonstrate preferred embodiments of the invention. It should be appreciated by those of skill in the art that the techniques disclosed in the examples, which follow represent techniques discovered by the inventor to function well in the practice of the invention, and thus can be considered to constitute preferred modes for its practice. However, those of skill in the art should, in light of the present disclosure, appreciate that many changes can be made in the specific embodiments, which are disclosed and still obtain a like or similar result without departing from the spirit and scope of the invention.

### Example 1

### Monitoring Seed Germination in a Controlled Environment

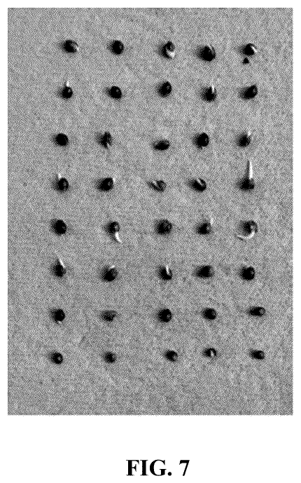

FIG. 7 shows an image of seeds germinated and monitored using an agriculture system of this disclosure. As shown in the image of FIG. 7, a number of seeds were placed on a moist cloth and allowed to germinate in the controlled environment of the agriculture system of this disclosure. The agriculture system of this disclosure allows germination to be efficiently monitored for a number of seeds simultaneously under stringently controlled conditions.

### Example 2

### Monitoring Egg Development in a Controlled Environment

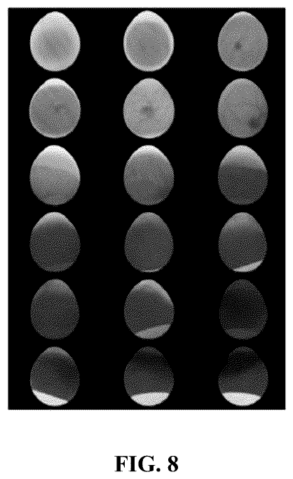

FIG. 8 shows an image of eggs developed in an agriculture system of this disclosure. Egg growth was monitored under controlled conditions to provide insights into how environment impacts development.

### Example 3

### Monitoring Fungal Growth in a Controlled Environment

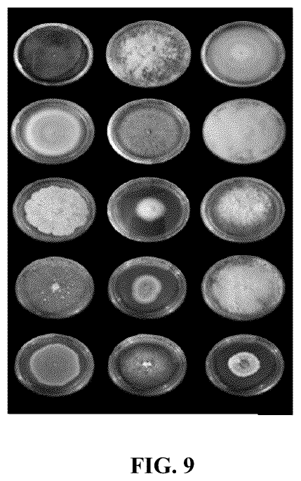

FIG. 9 shows images of fungi grown and monitored using an agriculture system of this disclosure. A number of petri dishes containing fungi were allowed to grow in the controlled conditions of the agriculture system, and growth was visually monitored with image sensors.

### Example 4

### Monitoring Plant Color in a Controlled Environment

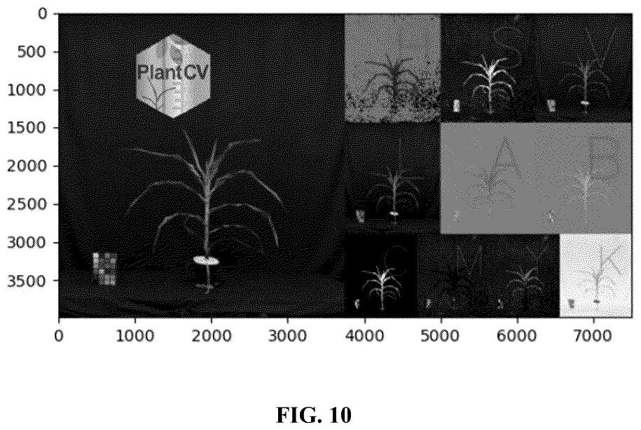

FIG. 10 shows side-view images of a plant grown and monitored using an agriculture system of this disclosure. A color reference (shown in the lower left of the image) allows different color properties of the plant to be determined and represented visually as shown in the array of nine smaller images, each representing a color component from the original larger image on the left.

### Example 5

### Example Image Analysis

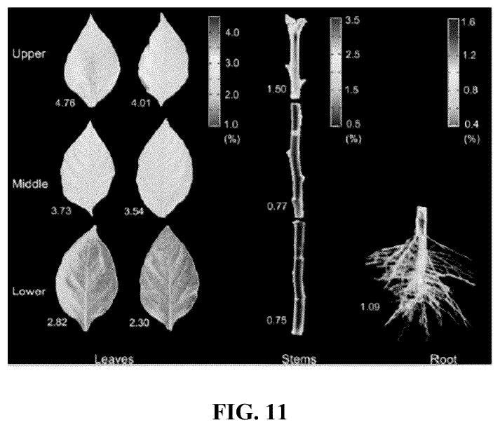

FIG. 11 shows image analysis results of leaves, stems, and roots of a plant grown and monitored using an agriculture system of this disclosure. Images obtained using a computer vision algorithm are color coded with a heat map showing properties of the various parts of the plant.

### Example 6

### Impact of Light Conditions on Plant Phenotype

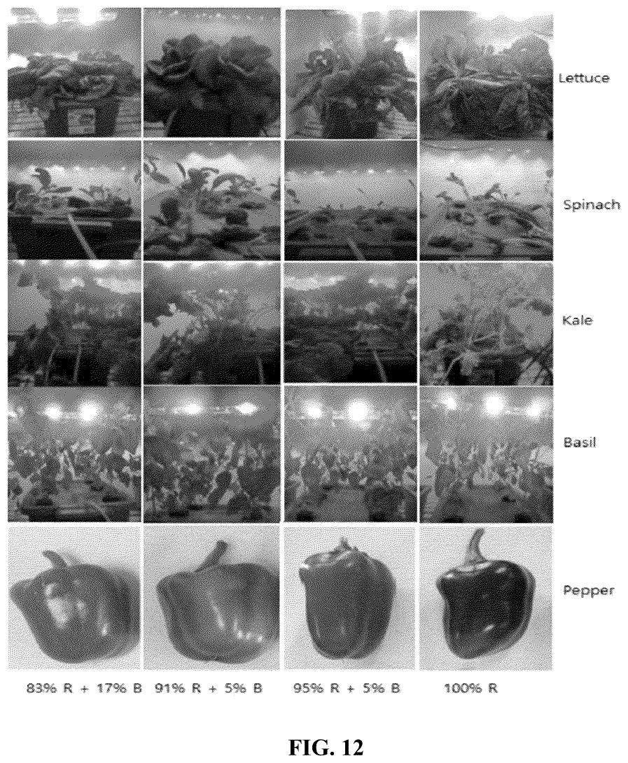

FIG. 12 shows images of different plants, including lettuce, spinach, kale, basil, and pepper, grown and monitored using an agriculture system of this disclosure under different light conditions with different percentages of red (R) and blue (B) light. As shown in the images, different plant phenotypes (e.g., size, color, shape) can be achieved under different lighting conditions. For example, the pepper is a darker color when grown under 100% red light than when some blue light is included. Based on this information, plant growth schedules can be generated to more consistently obtain target phenotypes than was possible using previous technology.

It should be understood that, while the system is primarily described herein in the context of monitoring and optimizing plant growth, the controlled environment system is not limited to plant specimens. The system can be readily adapted to monitor a wide variety of other biological specimens, such as animal eggs during development (e.g., avian or reptilian eggs), fungal cultures, or even the growth and behavior of small animals, such as insects in an ant farm or other contained habitats. Beyond biological specimens, the system is also well-suited for testing and monitoring the performance of environmentally responsive devices or products. For example, the system can be used to evaluate the accuracy and longevity of environmental sensors (e.g., light, humidity, or temperature sensors) by exposing them to controlled and variable conditions over time. Additionally, the system can be employed to test the durability and functional response of materials or products, such as fabrics or coatings, that are designed to react to changes in environmental parameters like light, temperature, or humidity. By providing precise control and continuous monitoring, the system enables comprehensive testing and analysis of both living and non-living specimens, thereby expanding its utility to a broad range of research, development, and quality assurance applications.

All of the systems and methods disclosed and claimed herein can be made and executed without undue experimentation in light of the present disclosure. While the systems and methods of this invention have been described in terms of preferred embodiments, it will be apparent to those of skill in the art that variations may be applied to the systems and in the steps or in the sequence of steps of the method described herein without departing from the concept, spirit, and scope of the invention. All such variations and modifications apparent to those skilled in the art are deemed to be within the spirit, scope, and concept of the invention as defined by the appended claims.

1. A system, comprising:
a container configured to hold a plant;
at least one sensor configured to collect data comprising at least one of (i) plant characteristic data corresponding to one or more characteristics of the plant and (ii) environment characteristic data corresponding to one or more characteristics of an environment in or around the plant;
at least one actuator configured to adjust a property of the environment in or around the plant;
an electronic display; and
a control subsystem communicatively coupled to the at least one sensor, the at least one actuator, and the electronic display, the control subsystem configured to:
receive the collected data;
cause display of at least a portion of the received data on the electronic display; and
control the at least one actuator to adjust the property of the environment based at least in part on the received data.

2. The system of claim 1, wherein the at least one sensor comprises at least one of an image sensor, a pH sensor, a temperature sensor, a humidity sensor, an electrical conductivity sensor, and a chemical sensor.

3. The system of claim 1, wherein:
the plant characteristic data comprises a plant image; and
the control subsystem is further configured to:
determine a plant size or plant color based on the plant image; and
cause display of the plant size or plant color on the electronic display.

4. The system of claim 1, wherein the at least one sensor comprises:
a top-view image sensor configured to collect top-view images of the plant; and
a side-view image sensor configured to collect side-view images of the plant.

5. The system of claim 4, wherein the control subsystem is further configured to:
determine, using the top-view images and side-view images, a plant mass of the plant;
cause display of the plant mass on the electronic display; and
control the at least one actuator to adjust the property of the environment based at least in part on the plant mass.

6. (canceled)

7. The system of claim 4, wherein the control subsystem is further configured to determine a plant height using the side-view images.

8. The system of claim 1, wherein the environment characteristic data comprises one or more of a temperature of the environment, a humidity level of air in the environment, an amount of carbon dioxide in the environment, a pH of soil in the container, a moisture level of the soil, and an amount or presence of one or more nutrients in the soil.

9. The system of claim 1, wherein the least one actuator comprises one or more of a light, a fluid pump, and a heater.

10. The system of claim 1, wherein the control subsystem is further configured to:
determine a plant growth characteristic based on the collected data; and
cause display of the plant growth characteristic on the electronic display.

11. The system of claim 10, wherein the control subsystem is further configured to:
determine that the plant growth characteristic is outside a predefined range associated with expected growth of the plant; and
in response to determining that the plant growth characteristic is outside the predefined range, provide a notification for display on the electronic display or on a user device in communication with the control subsystem, the notification indicating a corrective action is indicated.

12. The system of claim 1, wherein the control subsystem is further configured to:
determine, based on the collected data, that a growth objective is met; and
provide a notification for display on the electronic display or on a user device in communication with the control subsystem, the notification indicating that the growth objective is met.

13. The system of claim 1, wherein the control subsystem comprises a local controller comprising:
a memory configured to store the collected data; and
a processor configured to present a graphical user interface on the electronic display, the graphical user interface showing collected data and options for controlling the at least one actuator;
wherein the local controller is communicatively coupled to a server, wherein the server is configured to:
analyze collected data using one or more artificial intelligence or machine learning algorithms to generate analysis results; and
provide the analysis results to the local controller for presentation on the electronic display.

14. (canceled)

15. A method comprising, by a controller of a controlled-environment agriculture system:
receiving data collected by at least one sensor of the controlled-environment agriculture system, the received data comprising at least one of (i) plant characteristic data corresponding to one or more characteristics of a plant grown in the controlled-environment agriculture system and (ii) environment characteristic data corresponding to one or more characteristics of an environment in or around the plant;
causing display of at least a portion of the received data on an electronic display of the controlled-environment agriculture system; and
controlling at least one actuator of controlled-environment agriculture system to adjust a property of the environment based at least in part on the received data.

16. The method of claim 15, wherein:
the plant characteristic data comprises a plant image; and
the method further comprises:
determining a plant size or plant color based on the plant image; and
causing display of the plant size or plant color on the electronic display.

17. The method of claim 15, wherein the at least one sensor comprises:
a top-view image sensor configured to collect top-view images of the plant; and
a side-view image sensor configured to collect side-view images of the plant.

18. The method of claim 17, further comprising:
determining, using the top-view images and side-view images, a plant mass of the plant; and
causing display of the plant mass on the electronic display; and
controlling the at least one actuator to adjust the property of the environment based at least in part on the plant mass.

19. (canceled)

20. The method of claim 15, further comprising:
determining a plant growth characteristic based on the collected data;
causing display of the plant growth characteristic on the electronic display;
determining that the plant growth characteristic is outside a predefined range associated with expected growth of the plant; and
in response to determining that the plant growth characteristic is outside the predefined range, providing a notification for display on the electronic display or on a user device, the notification indicating a corrective action is indicated.

21. (canceled)

22. The method of claim 15, further comprising:
determining, based on the collected data, that a growth objective is met; and
providing a notification for display on the electronic display or on a user device, the notification indicating that the growth objective is met.

23. The method of claim 15, further comprising by a server communicatively coupled to the controller:
analyzing a portion of the received data using one or more artificial intelligence or machine learning algorithms to generate analysis results; and
providing the analysis results to the controller for presentation on the electronic display.

24. A control subsystem for a controlled-environment agriculture system, the control subsystem comprising at least one processor configured to:
receive data collected by at least one sensor of the controlled-environment agriculture system, the received data comprising at least one of (i) plant characteristic data corresponding to one or more characteristics of a plant grown in the controlled-environment agriculture system and (ii) environment characteristic data corresponding to one or more characteristics of an environment in or around the plant;
cause display of at least a portion of the received data on an electronic display of the controlled-environment agriculture system; and
control at least one actuator of controlled-environment agriculture system to adjust a property of the environment based at least in part on the received data.
